(19) United States
(12) Patent Application Publication
(10) Pub. No.: US 2019/0119162 A1
(43) Pub. Date: Apr. 25, 2019

(54) METHOD FOR RETARDING HYDRATION OF HYDRAULIC COMPOSITION SURFACE

(71) Applicant: CHRYSO, Issy les Moulineaux (FR)

(72) Inventors: Bruno PELLERIN, Avon (FR); Sandrine MATEO, Ury (FR); Sophie LACHENAUD, Paris (FR)

(21) Appl. No.: 16/230,371

(22) Filed: Dec. 21, 2018

Related U.S. Application Data
(62) Division of application No. 13/882,107, filed on Apr. 26, 2013.

(30) Foreign Application Priority Data
Oct. 26, 2010 (FR) 1058791

(51) Int. Cl. C04B 24/04; C04B 24/12; C04B 40/00; C04B 41/00; C04B 41/53

(52) U.S. Cl. CPC C04B 24/04; C04B 24/121; C04B 41/5323; C04B 41/009; C04B 40/0039

(57) ABSTRACT

A method for retarding hydration of a surface of a hydraulic composition includes shaping the hydraulic composition, applying an emulsion onto the surface of the hydraulic composition, and removing a film and a surface layer formed by a non-hardened hydraulic composition from the surface of the hardened hydraulic composition after hardening the hydraulic composition. The emulsion has an oily phase and an aqueous phase, in which the oily phase is dispersed in the aqueous phase. The emulsion includes a non-quaternary amine surfactant and an acid having a set-retarding effect.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the invention

The present invention relates to a useful emulsion in particular as a concrete surface retarder which may be removed without liquid.

### Description of the Related Art

A surface retarder gives the possibility of delaying hydration of the cement at the non-formed surface of a concrete. After the usual setting time, the cement matrix with retarded surface setting may be removed by washing, which gives the possibility of making the granules apparent and of obtaining particular sought esthetical effects.

Formulating a surface retarder as an aqueous solution of a setting retarder is known.

In order to protect the surface against bad weather during the setting, suspending the setting retarder in a resin solution with a solvent is moreover known. Surface retarders in a solvent phase however release VOCs (Volatile Organic Compounds) which are harmful for the user and the environment.

In order to avoid the problems related to the presence of solvents, document EP1526120 proposes a surface retarder in the form of a suspension of a setting retarder in a vegetable oil. These formulations with the retarded cement form fat crusts at the surface which are very difficult to remove after 24 hrs. These formulations then impose strict observance of the application time from 8 to 24 hrs, which in practice poses planning difficulties in the organization of the building site.

Further, all these formulations have a common major problem insofar that they require removal by washing with overpressurized water, typically under 100-150 bars. This method generates significant amounts (typically >1 m³ for 100 m²) of strongly alkaline water (pH >12) and highly loaded with suspended materials (SM>100g/l). Discarding these waters pose problems of pollution and may moreover cause clogging of waste water collection networks because of the re-hardening over time of the removed cement matrix.

### SUMMARY OF THE INVENTION

The goal of the present invention was then to propose a surface retarder formulation which does not have the mentioned drawbacks. In particular, it was sought to propose a surface retarder formulation which ensures rapid and efficient protection of the surface and which avoids the problems posed by the washing waters.

This goal is achieved according to the invention with a formulation as an emulsion which breaks upon contact with cement concrete in the fresh condition and which may be removed during a period exceeding 24 hrs.

### DETAILED DESCRIPTION OF THE PREFERRED EMBODIMENT

The formulation of the emulsion according to the invention is derived from that of roadwork bitumen emulsions in which the molten bitumen is emulsified with an acid aqueous solution and added with a non-quaternary amine surfactant. The emulsion is stable and may be sprayed on the roads. However, upon contact with ground including alkaline gravel or by adding limestone or Portland cement, the non-quaternary amine surfactant, protonated in an acid medium, precipitates in an alkaline medium by deprotonation, thus causing the immediate breaking of the emulsion.

In bitumen emulsions, the nature of the acid is of no importance and mineral acids such as hydrochloric acid are generally used. In the emulsion according to the invention in contrast, the acid is a specific constituent since it further provides a second function. Indeed, in addition to ensuring solubilization of the non-quaternary amine surfactant by lowering the pH of the aqueous phase, it acts as a retarder for the setting of the hydraulic composition.

Also, according to a first aspect, the emulsion according to the invention consists of an oily phase dispersed in an aqueous phase which comprises a non-quaternary amine surfactant and an acid with a set-retarding effect.

By the term of «acid with a set-retarding effect» is meant an acid which has the effect, when it is added to a hydraulic composition, of delaying its hardening by hydraulic setting as compared with the same hydraulic composition without such an agent.

In the present discussion by the term of «hydraulic composition» are meant compositions hardening as a result of hydration, and in particular compositions based on Portland cement like concrete and mortar. Hydraulic compositions which may include esthetically attractive granules such as gravels of the quartz, marble or granite type are particularly targeted.

The acid with a set-retarding effect preferably has a pK_{A} comprised between 2 and 5. Preferably the acid with a set-retarding effect is a carboxylic or hydroxycarboxylic acid. The carboxylic or hydrocarboxylic acid may include a saturated or unsaturated carbon chain and have one, two or three carboxylic groups as well as one, two, three hydroxyl groups or more, if necessary.

The acid with a set-retarding effect may also be present in the emulsion as a corresponding salt, notably of sodium, potassium or calcium.

The acid with a set-retarding effect may notably be selected from the group consisting in acetic acid, gluconic acid, citric acid, tartaric acid, malic acid and salts and mixtures thereof. Citric acid, tartaric acid and malic acid and salts and mixtures thereof are preferred.

The dosage of the acid with a set-retarding effect in the emulsion according to the invention may be selected according to the contemplated application. Indeed, for a given acid, a higher concentration will give the possibility of obtaining a more extensive deactivating effect. Most often, the content of the acid with the retarding effect will be comprised between 1 and 20%, preferably 1 to 15% by weight of the emulsion.

The emulsion according to the invention moreover contains a non-quaternary amine surfactant as an emulsifier. A surfactant has an amphiphilic structure which gives its particular affinity for interfaces of the oil/water type. The rather hydrophilic or hydrophobic nature of a surfactant is often expressed by the hydrophilic/lipophilic balance (HLB). The non-quaternary amine surfactant preferably has an HLB index comprised in the range from 2 to 18 and more particular from 2 to 8.

Non-quaternary amines may be protonated in an acid medium, thereby forming ammonium groups with a positive charge. However, when the pH of the medium becomes alkaline in contact with the hydraulic composition, the surfactant loses its charge and precipitates, leading to the breaking of the emulsion.

Therefore, a primary, secondary or tertiary amine and most particularly a primary amine will be selected as an emulsifier. The amine may optionally be alkoxylated, notably ethoxylated, or not.

The non-quaternary amine surfactant is preferably an amine bearing from 1 to 3 carbon chains each including at least 8 carbon atoms. Advantageously, this is diamine, and in particular a diamine of the following formula:

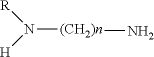

wherein R is a saturated or unsaturated, aliphatic or aromatic, linear or branched carbon chain including 8 to 22 carbon atoms, and preferably 12 to 18 carbon atoms and n is an integer comprised between 1 and 8 and preferably from 2 to 4.

Amines derived from fats of vegetable or animal origin are economical and easy to access and consequently of particular interest. The non-quaternary amine surfactant may in particular be selected from the group consisting in tallow, stearin, olein, coprah oil, palm oil, rapeseed oil, erucic rapeseed oil or soya bean oil diamine.

The emulsion according to the invention preferably comprises 0.01 to 10% and in particular 0.01 to 5% by weight of a non-quaternary amine surfactant.

The emulsion according to the invention may also contain one or more sugars. The presence of sugar in the emulsion allows an increase in the action depths of the surface retarder. Thus, an emulsion according to the invention formulated for exposing at the surface granules with a larger size, will preferably further comprise a sugar.

By the term of «sugar» in the context of the present invention, is meant carbohydrates such as glucose, dextrose, fructose, galactose, saccharose, maltose, lactose and mannose and mixtures thereof. From among these sugars, dextrose is preferred.

The emulsion according to the invention preferably comprises 0 to 20% and in particular 2 to 10% by weight of sugar.

By the term of «oily phase» within the scope of this document, is meant a hydrophobic non-aqueous phase, non-miscible with water and liquid at room temperature.

The oily phase may include fats of vegetable, animal or mineral origins, which may be liquid at room temperature or not. However, when they are not liquid at room temperature, the emulsion is preferably prepared under hot conditions, as described later on. The emulsion according to the invention is preferably a non-bituminous emulsion. Advantageously, it therefore does not include any naphthenic or aromatic hydrocarbon. However, it may contain aliphatic mineral oils. Moreover, it is advantageously without any curing product of the acrylic polymer or wax type.

Among the large variety of fats which may be contemplated, mention may in particular be made of vegetable oils selected from rapeseed oil, palm oil, coprah oil, castor oil, groundnut oil, grape pip oil, maize oil, canola oil, flax oil, coconut oil, soya bean oil and mixtures thereof.

The animal oils may be in particular selected from tallow, wool oil, lard oil, herring oil, cod liver oil, sardine oil, fish oil and lanoline oil and mixtures thereof.

The mineral oils in particular include fractions including on average 18 to 22 carbon atoms, notably clear mineral oil.

The amount of oily phase in the emulsion according to the invention may widely vary. Generally, the emulsion comprises 5 to 50% by weight, preferably 10 to 40% by weight of oily phase and 50 to 95%, preferably 60 to 90% by weight of aqueous phase.

Advantageously, the emulsion is stable during storage. In order to facilitate the application, for example by spraying, it preferably has a low flow viscosity for example comprised between 10 and 50 s (flow time of an AFNOR No. 4 cut).

### Method for Preparing the Emulsion

According to a second aspect, the invention relates to a method for preparing an emulsion as described above.

The emulsion according to the invention is easy to prepare with known methods as such and does not require any specific piece of equipment. In particular, it is accessible through a method comprising the steps of:
(i) preparing the aqueous phase comprising the set-retarding acid, the non-quaternary amine surfactant, and if necessary the other adjuvants;
(ii) preparing the oily phase; and
(iii) mixing both phases in a suitable device until an emulsion is obtained.

As mentioned above, when one or several constituents of the oily phase are solid at room temperature, it is preferable to heat them up in order to ensure a homogeneous mixture and in particular a homogeneous distribution of the non-quaternary amine surfactant. In this case, it is recommended to also heat up the aqueous phase to a neighboring temperature.

The aqueous phase will comprise one or several set-retarding acids as well as one or several sugars if necessary. The aqueous phase may also contain other customary adjuvants such as anti-foam agents, thickeners, coloring agents and opacifiers. It may moreover also contain dispersants and petroleum resins, notably with view to improving the curing performances.

A device suitable for carrying out step (iii) of the method described above is for example a mixer of the emulsifier type.

A storage/stable homogeneous emulsion is obtained with low viscosity and consequently easily sprayable onto the surface to be retarded.

### Method for Use of the Emulsion

As mentioned above, the emulsion according to the invention is particularly useful for surface retarding of hydraulic compositions, notably concrete.

Also, according to a third aspect, the invention is directed to a method for surface retarding of a hydraulic composition, comprising the steps:
(a) shaping the hydraulic composition;
(b) applying on the surface of the hydraulic composition, the emulsion according to the invention which by breaking releases the oily phase; and
(c) after hardening of the hydraulic composition, removing the film formed with the non-hardened hydraulic composition surface layer.

Advantageously, step (a) is carried out by casting. The concrete to be retarded may also be set into place by floating, and if necessary by vibration.

The step (b) for application onto the surface of the hydraulic composition is easily carried out by spraying.

Surprisingly, the emulsion is efficient at the same dosage as a conventional formulation.

Preferably, the application of the emulsion is efficient when it is achieved in an amount from 100 to 400 g/m² and preferably from 150 to 250 g/m².

In contact with the fresh hydraulic composition, the emulsion according to the invention instantaneously breaks in order to form a continuous water-repellent protective layer while the active materials, notably the setting retarder, diffuses into the surface layer of the hydraulic composition for generating the setting delay therein.

After 12 to 24 hours of hardening of the bulk of the hydraulic composition, the surface with retarded setting has a dry aspect. It is then possible to expose the granules by removing the formed film and the surface layer of the hydraulic composition. This step may be carried out as customarily by washing with a water jet.

However, one of the main advantages of the emulsion according to the invention is the fact that it may be removed under dry conditions, i.e. without using water, for up to 96 hours, unlike traditional retarders which are very difficult to remove after 24 hours. Also, according to a preferred embodiment of the method, step (c) is carried out under dry conditions, for example with brushing, notably by means of a rotary brush. Advantageously, the residues are simultaneously sucked up by means of a suction device coupled with the brush.

It is possible to easily get rid of the surface layer including the retarded cement and the emulsion according to the invention from the surface and a surface is obtained which shows the granules in order to lead to the sought esthetical aspect.

Without intending to be bound by a particular theory, it is assumed that the surprising effects are due to the formation of an aqueous film superposed with an oily film upon breaking of the emulsion in contact with the surface. Because of its particular affinity, the aqueous phase forms an aqueous film on the surface of the hydraulic composition while the oily phase forms an oily film positioned above the aqueous film.

Unlike conventional formulations, these films may be very homogeneous, or even continuous by the particular breaking mechanism of the emulsion. The emulsion according to the invention then gives the possibility of obtaining a combination of specific effects in that the aqueous phase ensures homogeneous diffusion of the setting retarder in the surface layers of the hydraulic composition and at the same time prevents penetration of the oily phase into the hydraulic composition and the formation of fat crusts. On the other hand, the oily film ensures by its curing effect, efficient protection of the surface against evaporation and bad weather and thus prevents drying of the concrete.

Thus, the emulsion according to the invention gives the possibility of obtaining the formation of a friable very homogeneous surface which may be removed under dry conditions for an extended time, ranging up to 96 hours. Its application may then be carried out under very diverse circumstances, including at the end of the week, without requiring specific follow-up.

### Use

As mentioned earlier, the described emulsion is particularly useful as a surface retarder of hydraulic compositions, notably due to the fact that it may be removed under dry conditions, for example by brushing.

Also, according to a last aspect, the invention is directed to the use of an emulsion described for surface retarding of hydraulic compositions, notably of concretes.

Use may be made in particular by application onto the surface of the freshly shaped hydraulic composition, as explained earlier.

The invention will be described in more detail in the following examples, given as a pure illustration.

### EXAMPLES

### Example 1

In a suitable container with a capacity of 150 L and equipped with heating and stirring means, 68.9 kg of water are introduced and heated to 50° C. and then 7.5 kg of citric acid are introduced with stirring. Once the acid has dissolved, 2.4 kg of tallow diamine heated up beforehand to the same temperature are introduced, while ensuring vigorous mixing. To the thereby obtained mixture, are added the adjuvants, i.e. 1.6 kg of an anti-foam agent, 1.6 kg of a thickener and 3 kg of an opacifiying pigment.

To the thereby prepared aqueous phase, the oily phase is added, consisting of 8.5 kg of wool fat and 6.5 kg of clear mineral oil heated beforehand to a temperature of 50° C. and vigorous mixing is continued, until a fine emulsion is obtained.

After cooling, a storage-stable emulsion with a milky white aspect, with a viscosity of 18 seconds on an AFNOR No. 4 Cut. Table 1 below recalls the composition of the prepared emulsion.

TABLE 1
Composition of the emulsion

| Constituent | Amount [kg] |
|---|---|
| Aqueous phase: | |
| Water | 68.90 |
| Citric acid | 7.50 |
| Anti-foam agent | 1.60 |
| Thickener | 1.60 |
| Opacifying pigment | 3.00 |
| Fat tallow diamine | 2.40 |
| Oily phase: | |
| Wool fat | 8.50 |
| Clear mineral oil | 6.50 |
| Total | 100.00 |

The obtained emulsion was sprayed, as such, on a fresh concrete surface of a composition given in Table 2 below with a dosage of 200 g/m². After a few minutes, the formation of a water-repellent protective film which rapidly dries, is observed.

After 24 hours, the concrete had set in depth and the surface was dry but friable. The film and the surface layer of the concrete were easily removed by means of a brush equipped with a suction device (Manufacturer Eureka) for exposing the underlying granules.

The same test was conducted again after 96 hours outdoors in dry weather and at a temperature of 25° C. during the day and 15° C. during the night, with identical results.

Like conventional surface retarders, the emulsion according to the invention may be supplied in several hollow depths by acting on the formulation of the setting retardant system and adding one or several sugars if necessary.

TABLE 2
Composition of the concrete

| Constituant | Amount [kg/m³] |
|---|---|
| CEM I 52.5NSPLC | 330 |
| Gravel 6/10 Lampourdier | 1290 |
| Sand 0/4 Bernieres | 630 |
| CHRYSO ® Air G100 | 0.05% |
| CHRYSO ® Plast CER | 0.35% |
| Water | 180 |
| Total | 2432.8 |

The curing effect obtained with the emulsion according to the example was evaluated as compared with a conventional formulation in an aqueous phase and in a phase with a solvent.

For this purpose, a curing test was carried out on a hydraulic composition of the self-leveling covering (SLC) type according to the operating conditions of the NF P 18-370 standard with a retarder dosage of 200 g/m².

The results are summarized in Table 3 below. It is seen that, everything being moreover comparable, the formulation as an emulsion according to the invention gives the possibility of obtaining a highly satisfactory curing effect without using any solvents.

TABLE 3
Curing effect

| | Protection coefficient [%] | |
|---|---|---|
| Retarder formulation | After 6 hrs | After 24 hrs |
| Example 1 | 60 | 42 |
| Formulation in an aqueous phase | 0 | 0 |
| Formulation in a phase with solvent(s) | 91 | 69 |

The emulsion according to the present invention, by means of its immediate breaking by simple contact with the fresh hydraulic composition, does not emit any VOCs, ensures a good curing effect on the concrete and leaves a dry and non-muddy surface. Moreover, the emulsion according to the invention may be removed under dry conditions and therefore does not generate any abundant, loaded and polluted washing waters. Finally, the emulsion according to the invention may be removed for up to 96 hours after application, which notably facilitates its implementation.

What is claimed is:

1. A method for retarding hydration of a surface of a hydraulic composition, comprising:
(a) shaping the hydraulic composition;
(b) applying onto the surface of the hydraulic composition, an emulsion comprising an oily phase and an aqueous phase, wherein the oily phase is dispersed in the aqueous phase in the emulsion, wherein the emulsion comprises a non-quaternary amine surfactant and an acid having a set-retarding effect of the hydraulic composition,
wherein the non-quaternary amine surfactant is a diamine represented by the following formula: 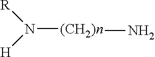
wherein R is a saturated or unsaturated, aliphatic or aromatic, linear or branched carbon chain including 8 to 22 carbon atoms, and n is an integer comprised between 1 and 8,
wherein the emulsion comprises 5 to 40% by weight of the oily phase to total amount of the emulsion, and
wherein the emulsion releases the oily phase when the emulsion is broken on the surface of the hydraulic composition; and
(c) after hardening the hydraulic composition, removing a film and a surface layer formed by a non-hardened hydraulic composition from the surface of the hardened hydraulic composition.

2. The method according to claim 1, wherein the hydraulic composition is shaped by a casting in said (a).

3. The method according to claim 1, wherein the emulsion is applied by a spraying in said (b).

4. The method according to claim 1, wherein said hardening and removing in said (c) are carried out under a dry condition.

5. The method according to claim 1, wherein the acid with the set-retarding effect is a carboxylic or hydroxycarboxylic acid.

6. The method according to claim 1, wherein the acid with the set-retarding effect is selected from the group consisting of acetic acid, gluconic acid, citric acid, tartaric acid, malic acid, salts and mixtures thereof.

7. The method according to claim 1, wherein the non-quaternary amine surfactant is a compound with an amine function substituted with one to three carbon chains each with at least 8 carbon atoms.

8. The method according to claim 1, wherein the emulsion comprises a sugar.

9. The method according to claim 1, wherein the sugar is selected from the group consisting of glucose, dextrose, fructose, galactose, saccharose, maltose, lactose, mannose and mixtures thereof.

10. The method according to claim 1, wherein the emulsion has a flow viscosity comprised between 10 and 50 seconds of a flow time measured by an AFNOR No. 4 Cut.

11. The method according to claim 1, wherein the hydraulic composition is a concrete or a mortar.

12. The method according to claim 1, wherein the non-quaternary amine surfactant is included at a interface between the aqueous phase and the oily phase in the emulsion.
